(19) United States
(12) Patent Application Publication
(10) Pub. No.: US 2025/0260306 A1
(43) Pub. Date: Aug. 14, 2025

(54) POWER SUPPLY AND A METHOD PERFORMED BY A POWER SUPPLY

(71) Applicant: Telefonaktiebolaget LM Ericsson (publ), Stockholm (SE)

(72) Inventors: Qiang LIU, Beijing (CN); Lackis ELEFTHERIADIS, Valbo (SE); Yandong LI, Beijing (CN); Yanjie XIN, BEIJING (CN)

(73) Assignee: Telefonaktiebolaget LM Ericsson (publ), Stockholm (SE)

(21) Appl. No.: 18/704,823

(22) PCT Filed: Oct. 26, 2021
(86) PCT No.: PCT/CN2021/126376

§ 371 Date: Apr. 25, 2024

(51) Int. Cl. H02M 1/32; H02M 7/217

(52) U.S. Cl. CPC H02M 1/32; H02M 7/217

(57) ABSTRACT

A power supply (2000), a method of operating a power supply, a computer program (1020) and a computer program product (1010) is provided. The power supply is adapted to convert an oscillating Alternating Current, AC, to a single-directional Direct Current, DC. The power supply comprises a rectifier bridge (2100); a capacitor (2700); at least a first, a second and a third Electronic Switching Device, BSD (2400, 2500, 2600); a resistor (2300); a controller (2800) connected to the first, second and third ESDs. The controller is adapted to control switching of the first, second and third ESDs to operate the power supply in one of four modes of operation.

### TECHNICAL FIELD

The invention relates to a power supply, a method performed by a power supply, a corresponding computer program, and a corresponding computer program product.

### BACKGROUND

Alternating Current/Direct Current, AC/DC, rectifiers are widely used in communication networks and in numerous consumer electronics. In communication networks, these rectifiers are used in radio signal processing units, edge nodes, edge data centers, radio base stations, micro radio base stations, etc. In the case of a start-up, a recovery from a voltage sag or a voltage swelling of an electronic device, the currently used AC/DC rectifiers suffer from an inrush current once the power is restored. Additionally, the current technology of AC/DC rectifiers also suffer from an inrush current when the applied voltage is increased. AC/DC rectifiers will henceforth be referred to as rectifiers in the text. An inrush current is in most cases a large current spike that flows through the rectifier, to bulk capacitors placed at the output. The rectifier is responsible for limiting the inrush current in the electronic device to avoid damage or degradation of internal components such as fuses, cables, etc. and even external components.

The aforementioned rectifiers could for example be used with an electronic apparatus such as a Radio Base Station, RBS. For the purpose of illustrating a subset of RBS, let us consider a street macro RBS. A street macro RBS may comprise several rectifiers connected to each other in parallel. These rectifiers in the street macro RBS typically use a load balancing circuit to regulate the incoming power supply to the base station. In some cases, the street macro RBS may comprise a single, high power/current, rectifier to handle the inrush current. This type of single rectifier makes the electronic apparatus more compact as compared to other configurations.

As an example, street macro RBSs typically have a power rating of 3-4 kW for each node and are deployed in a highly distributed manner in the network. If we consider that more than one such street macro RBS are connected to the power grid, these RBSs will affect the power grid from multiple points of connection. The power grid is affected due to the operational nature of these RBSs and more specifically, negatively affected due to the variable inrush current generated towards the power grid via the in-built or connected rectifiers in the RBSs.

In case of no inrush protection at such electronic apparatus, an overvoltage condition that exceeds the predetermined threshold will cause damage to the rectifier internal components. Some of the existing solutions to combat this inrush current issue trigger the rectifier to disconnect its internal components that are vulnerable to damage. Another way of tackling the issue of the inrush current is by using an in-built resistor and a relay that suppress the inrush current to an acceptable level, thereby saving the internal components from damage.

The existing solutions and techniques to limit or tackle the issue of inrush current have several disadvantages. For example, disconnecting a relay from the apparatus may take a long time, at least in the order of several milliseconds, leading to a slower reaction time and eventually damaging the rectifier's internal components in case of rapid power fluctuations.

U.S. Pat. No. 9,755,419 B2 discloses an apparatus and methods for selective protection of an electrical load from disturbances on an input power line. The document discloses a power protection circuit that includes a power supply and a switch for disconnecting the input power line from the load. The apparatus as described in the document is that it typically uses a Schottky diode to maintain a certain voltage level in the beginning of the inrush mode of operation. One of the disadvantages is that the Schottky diode has a high reverse current leakage, which is detrimental to the power protection circuit.

U.S. Pat. No. 7,355,368 B2 discloses a boost converter including an input rectifying bridge adapted to rectify an input AC voltage, a first inductor connected to the input rectifying bridge, an output capacitor coupled to first inductor for connection to a DC bus, a first bidirectional semiconductor switch coupled between the output capacitor and the first inductor, a second inductor positioned adjacent to the first inductor with a first end connected to a common ground and a second bidirectional semiconductor switch positioned between the second inductor and the output capacitor. The document further discloses an inrush control device that is provided to control the first and second bidirectional semiconductor switches to prevent current inrush.

### SUMMARY

An object of the invention is to protect an electronic apparatus from inrush current in a reliable way.

This and other objects are met by means of different aspects of the invention, as defined by the independent claims. Embodiments of the invention are characterized by the dependent claims.

According to a first aspect, a power supply is provided, wherein the power supply is adapted to convert an oscillating Alternating Current, AC, to a single-directional Direct Current, DC. The power supply comprises:
a rectifier bridge at an input, the rectifier bridge having a first DC terminal and a second DC terminal;
a capacitor at an output, the capacitor having a first DC terminal connected to the first terminal of the rectifier bridge and a second DC terminal connected to the second terminal of the rectifier bridge;
at least a first, a second and a third Electronic Switching Device, ESD, wherein:

a drain of the first ESD is connected to the first DC terminals and a source of the first ESD is connected to the second DC terminals;
the second and third ESDs are connected between the first DC terminals such that:

a drain of the second ESD is connected to a drain of the third ESD, a source of the third ESD is connected to the drain of the first ESD, and a source of the second ESD is connected to the first DC terminal of the capacitor;
an inductor connected between the first DC terminal of the rectifier bridge and the drain of the first ESD;
a resistor connected between the second DC terminal of the rectifier bridge and the source of the first ESD; and
a controller connected to the first, second and third ESDs.

The controller is adapted to control switching of the first, second and third ESDs to operate the power supply in one of four modes of operation:
a) a first mode, wherein:
   the first and the second ESDs are turned off, and the third ESD is turned on;
b) a second mode, wherein:
   the first ESD is turned off, the third ESD is turned on and the second ESD operates in a first operational region;
c) a third mode, wherein:
   the first ESD is turned off, the second and third ESDs are turned on;
d) a fourth mode, wherein:
   the second ESD is turned on, and the first ESD and third ESD are operated to turn on and turn off alternatively to maintain a predetermined level of a voltage across the capacitor. The power supply is adapted to enter the four modes of operation sequentially.

According to an embodiment, the controller is adapted to control the switching of the first, second and third ESDs to operate the power supply in a fifth mode of operation, wherein the first, second and third ESDs are turned off. Hereby is achieved that the power supply is turned off.

According to an embodiment, the controller comprises a first, a second and a third input line and a first, a second and a third output line. A first, second and third signal are received at the first, second and third input line of the controller, respectively.

According to an embodiment, the first signal is indicative of a voltage across the resistor, the second signal is indicative of a current passing through the resistor and the third signal is indicative of a voltage across the capacitor.

According to an embodiment, the power supply is adapted to receive a signal at the input to activate the first mode.

According to an embodiment, the controller is adapted to activate the second mode if the voltage across the capacitor is less than the predetermined level.

According to an embodiment, the controller is adapted to activate the third mode when a voltage across the capacitor is greater than the predetermined level. Hereby is achieved that the third ESD is turned on.

According to an embodiment, the predetermined level is a predetermined voltage.

According to an embodiment, the controller is adapted to activate the fourth mode when a current at the input is reduced to an acceptable operational current and the voltage across the capacitor reaches a predetermined voltage threshold.

According to an embodiment, a voltage clamping device is connected in parallel to the first ESD. The voltage clamping device may for example be a voltage dependent resistor, VDR. Hereby is achieved that the VDR prevents damage to the first ESD and the second ESD during a transient stage when an additional reversed voltage is imposed by the controller on the first ESD and the second ESD.

According to an embodiment, the first, second and third ESDs are MOSFETs. Hereby is achieved that latency is reduced.

According to an embodiment, the first operational region for the second ESD in the third mode is a linear region. Hereby is achieved that the second ESD can, for example, work as a variable resistor.

According to an embodiment, the predetermined level of the signal across the capacitor is based on design parameters of the power supply.

According to an embodiment, the fourth mode of operation is a normal mode of operation. According to an embodiment, switching times of the first, second and third ESDs are different. According to an embodiment, the inductor, the second and third ESDs are part of a boost converter.

According to an embodiment, the controller and the rectifier bridge are implemented as separate physical entities. Hereby is achieved that the power supply has a reduced complexity.

In other embodiments, the controller and the rectifier bridge are implemented as a single physical entity, for example using the same cover or box. Hereby is achieved that an electronic apparatus used with the power supply can accommodate more components.

According to an embodiment, the power supply comprises an interleaved PFC circuit.

According to an embodiment, the first DC terminal of the rectifier bridge is a positive terminal, and the second DC terminal of the rectifier bridge is a negative terminal.

According to an embodiment, the controller comprises a logic controller, a signal adder, a signal multiplier, a proportional-integral-derivative, PID, controller and a pulse wave modulator, PWM.

According to an embodiment, the controller comprises processing circuitry. The processing circuitry comprises a processor and a memory, wherein the memory contains instructions executable by the processor.

According to an embodiment, the controller is implemented via software code.

According to a second aspect, an electronic apparatus comprising a power supply of the first aspect is provided. The electronic apparatus may for example be a communications network node such as a base station, a router, a gateway, an access point, or any other communications network node. The electronic apparatus may also be a consumer electronic device such as a vacuum cleaner, microwave or any other consumer electronic device.

According to a third aspect, a computing system comprising a power supply of the first aspect is provided.

According to a fourth aspect, a method performed by a power supply is provided, wherein the power supply is adapted to convert an oscillating Alternating Current, AC, to a single-directional Direct Current, DC. The power supply comprises:
a rectifier bridge at an input, the rectifier bridge having a first DC terminal and a second DC terminal;
a capacitor at an output, the capacitor having a first DC terminal connected to the first terminal of the rectifier bridge and a second DC terminal connected to the second terminal of the rectifier bridge;
at least three Electronic Switching Devices, ESDs with corresponding body diodes, wherein: the drain of the first ESD is connected to the first DC terminals and the source of the first ESD is connected to the second DC terminals;
the second and third ESDs are positioned between the first DC terminals such that:

a drain of the second ESD is connected to a drain of the third ESD, a source of the third ESD is connected to the drain of the first ESD, and a source of the second ESD is connected to the first DC terminal of the capacitor;
an inductor connected between the first DC terminal of the rectifier bridge and the drain of the first ESD;
a resistor connected between the second DC terminal of the rectifier bridge and the source of the first ESD; and
a controller connected to the first, second and third ESDs.

The method comprises:

the controller controlling switching of the first, second and third ESD to operate the power supply in one of four modes of operation, wherein:
a) in a first mode:
   the first and the second ESDs are turned off, and the third ESD is turned on;
b) in a second mode:
   the first ESD is turned off, the third ESD is turned on and the second ESD operates in a first operational region;
c) in a third mode:
   the first ESD is turned off, the second and third ESDs are turned on;
d) in a fourth mode:
   the second ESD is turned on, and the first ESD and third ESD are operated to turn on and turn off alternatively to maintain a predetermined level of a voltage across the capacitor.

The four modes of operation being entered sequentially.

According to an embodiment, the controlling comprises switching of the first, second and third ESDs to operate the power supply in a fifth mode of operation, wherein the first, second and third ESDs are turned off.

According to an embodiment, the controlling comprises sending trigger signals to the first, second and third ESDs.

According to an embodiment, the controller comprises a first, a second and a third input line and a first, a second and a third output line. A first, second and third signal are received at the first, second and third input line of the controller, respectively.

According to an embodiment, the controlling comprises activating the first mode upon reception of a signal at the input.

According to an embodiment, the controlling comprises activating the second mode when a voltage across the capacitor is less than the predetermined level.

According to an embodiment, the controlling comprises activating the third mode when a voltage across the capacitor is greater than the predetermined level.

According to an embodiment, the predetermined level is a predetermined voltage.

According to an embodiment, the controlling comprises activating the fourth mode is achieved when the current at the input reduces to an acceptable operational current and the input voltage across the capacitor reaches a predetermined voltage threshold.

According to an embodiment, the first, second and third ESDs are MOSFETs.

According to an embodiment, the first operational region for the second ESD in the third mode is a linear region.

According to an embodiment, the predetermined level of the signal across the capacitor is determined based on design parameters of the power supply.

According to an embodiment, the fourth mode of operation is a normal mode of operation. According to an embodiment, switching times of the first, second and third ESDs are different. According to an embodiment, the inductor, the resistor, the second ESD and third ESD are part of a boost converter.

According to an embodiment, the controller and the rectifier bridge are implemented as separate physical entities. In other embodiments, the controller and the rectifier bridge are implemented as a single physical entity.

According to an embodiment, the power supply comprises an interleaved PFC circuit.

According to an embodiment, the first DC terminal of the rectifier bridge is a positive terminal, and the second DC terminal of the rectifier bridge is a negative terminal.

According to an embodiment, the controller comprises a logic controller, a signal adder, a signal multiplier, a proportional-integral-derivative, PID, controller and a pulse wave modulator, PWM.

According to an embodiment, the controller comprises processing circuitry. The processing circuitry comprises a processor and a memory, wherein the memory contains instructions executable by the processor.

According to an embodiment, the first signal is indicative of a voltage across the resistor, the second signal is indicative of a current passing through the resistor and the third signal is indicative of a voltage across the capacitor.

According to an embodiment, the controller is implemented via software code.

According to a fifth aspect, a computer program, comprising instructions which, when executed on a processing circuitry, cause the processing circuitry to carry out the method according to any one of the embodiments of the fourth aspect.

According to a sixth aspect, a computer program product stored on a non-transitory computer readable (storage or recording) medium and comprising instructions that, when executed by a processor of an apparatus, cause the apparatus to perform the method according to any one of the embodiments of the fourth aspect.

In embodiments where there is a risk of electric arcing, the power supply can prevent an electric arc during hot plug, and limit large current during swelling and recovery from voltage sag. The power supply, the method, the computer program and the computer program product can be used in various applications such as communications network node such as radio base station, routers, gateways, consumer electronics such as vacuum cleaners, microwave ovens, etc. Other applications of the power supply, the method, the computer program and the computer program product are in computing systems such as data centers on the edge, edge computers, micro data centers, etc.

### BRIEF DESCRIPTION OF THE DRAWINGS

The above, as well as additional objects, features and advantages of the invention, will be better understood through the following illustrative and non-limiting detailed description of embodiments of the invention, with reference to the appended drawings, in which:

FIG. 1 illustrates an inrush current limiter circuit.

FIG. 2 shows a power supply, in accordance with an embodiment of the invention.

FIG. 3 illustrates a controller, in accordance with an embodiment of the invention.

FIG. 4 shows an equivalent RLC loop for the power supply operating in the second mode of operation, in accordance with an embodiment of the invention.

FIG. 5 shows a power supply with an interleaved PFC, in accordance with an embodiment of the invention.

FIG. 6A is a flowchart depicting a method, in accordance with an embodiment of the invention.

FIG. 6B is a flowchart depicting a method, in accordance with an embodiment of the invention.

FIG. 7 is a block diagram of a controller, in accordance with an embodiment of the invention.

FIG. 8A shows a power supply placed inside an electronic apparatus, in accordance with an embodiment of the invention.

FIG. 8B shows a power supply placed outside an electronic apparatus, in accordance with an embodiment of the invention.

FIG. 9 is a block diagram of a controller, in accordance with an embodiment of the invention.

FIG. 10 is a computer program product, in accordance with an embodiment of the invention. All the figures are schematic, not necessarily to scale, and generally only show parts which are necessary in order to elucidate the invention, wherein other parts may be omitted or merely suggested.

### DETAILED DESCRIPTION

The invention will now be described more fully hereinafter with reference to the accompanying drawings, in which certain embodiments of the invention are shown. This invention may, however, be embodied in many different forms and should not be construed as limited to the embodiments set forth herein. Rather, these embodiments are provided by way of example so that this disclosure will be thorough and complete, and will fully convey the scope of the invention to those skilled in the art.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

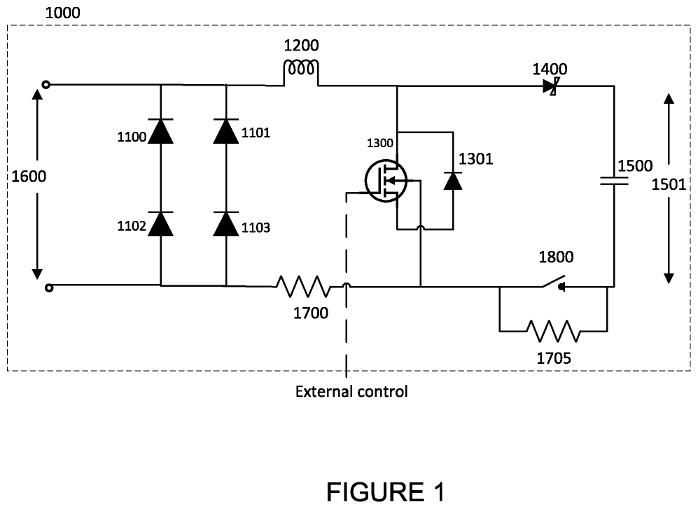

FIG. 1 shows an example of an inrush current limiting circuit to tackle the issue of inrush current. The inrush current limiting circuit of FIG. 1 comprises a relay 1800, resistor 1705, and a typical Power Factor Correction, PFC, circuit 1000. The relay 1800 and resistor 1705 support in limiting inrush current in the circuit during start-up, even after recovery from a power outage. As mentioned already, a disadvantage of such a solution is that the response time of the relay is slow, that is, at least in the order of milliseconds. Thus, this solution is not optimal during voltage sag or undervoltage conditions. The PFC circuit comprises four rectifier diodes 1100-1103; an inductor 1200, L1; a MOSFET 1300, M1 with corresponding body diode 1301; a Schottky diode 1400; a bulk capacitor 1500; two resistors 1700, 1705; and the relay 1800. The MOSFET 1300, can alternatively be referred to as a switch 1300.

In FIG. 1, when AC power 1600 is supplied to the device from the power grid, with for example 230 V AC, the switch 1300, starts the operation of the PFC 1000. The switch alternatively turns on and off to maintain a proportionate output voltage across the capacitor 1501, Vc, of the PFC 1000. When the load at the output capacitor is varied, the internal control functionality of the PFC continuously and tries to deliver the desired output power, while at the same time tries to maintain a stable output voltage 1501, Vc, by adjusting the pulse duration, that is, the ON/OFF time of the switch 1300. The pulse duration is adjusted continuously to obtain a Pulse Width Modulation, PWM. The parameters inside the controller's circuitry are stabilized according to a fixed reference voltage, and a fixed frequency, both of which are pre-set to stabilize the PFC 1000. This process of continuously adjusting the parameters to deliver the desired output power starts when the AC power 1600 starts to be supplied at the device and continues until the input power source is disconnected or the input power source is shut down. The entirety of the process is herein referred to as normal mode of operation or PFC mode of operation.

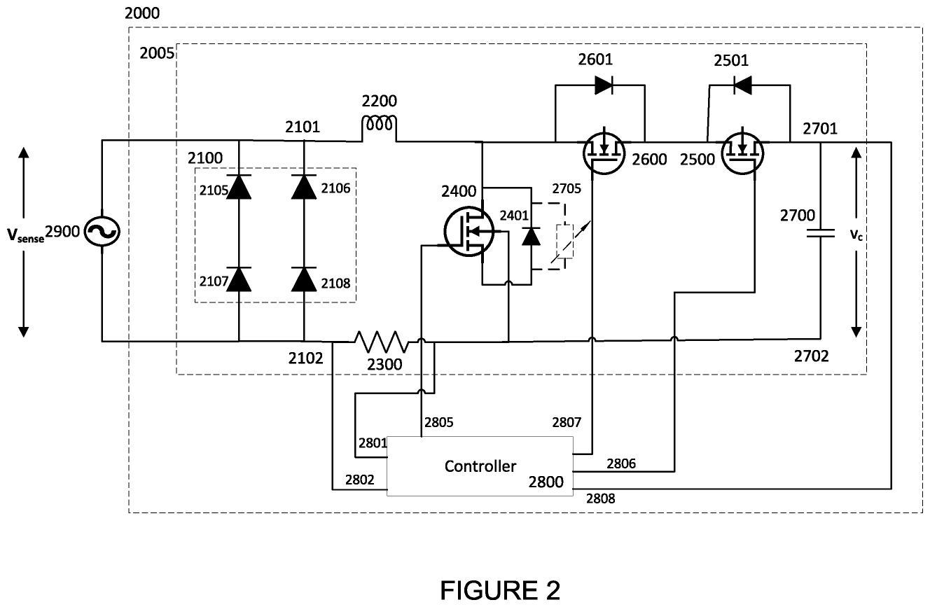

FIG. 2 is a representation of an embodiment of a power supply 2000, wherein the power supply 2000 is for use with an electronic apparatus 9000. The power supply 2000 comprises a rectifier bridge 2100 comprising four diodes 2105-2108; an inductor 2200; a resistor 2300; three Electronic Switching Devices, ESDs, 2400, 2500, 2600 with corresponding body diodes, 2401, 2501 and 2601; a capacitor 2700; a controller 2800; and optionally, a voltage clamping device 2705. An equivalent of a PFC circuit 2005 in the power supply's circuitry is the setup of four diodes 2105-2108, inductor 2200, resistor 2300, three ESDs 2400, 2500, 2600 and capacitor 2700. The PFC circuit 2005 is adapted/configured/operable to operate in one of two modes-normal mode of operation, also referred to as PFC mode of operation, and an inrush mode. The various parameters of the circuitry in the power supply, such as for example the value of the resistance of resistor 2300, inductance of inductor 2200, capacitance of capacitor 2700, frequency of the ESDs 2400, 2500, 2600 define an acceptable AC input voltage range. For example, the acceptable AC input voltage range may be 100 V to 250 V AC. Another example for the acceptable AC input voltage range may be 173 V to 415 V AC, in a three phase AC input arrangement. The power supply is adapted/configured/operable to receive an input AC voltage 2900 and convert the input AC voltage 2900 into DC voltage, VDC. Furthermore, the power supply is configured to monitor the current passing through resistor 2300, IR, the voltage across resistor 2300, VR, and the input voltage, Vsense. The power supply is configured to operate in four modes based on the value of Vsense.

The parameters pertaining to the power supply's circuitry are not limited to the mentioned parameters. The acceptable minimum AC input voltage 2901 can be referred to as Vsense-min, the acceptable maximum AC input voltage 2902 can be referred to as Vsense-max and the over voltage, that is, the voltage across the rectifier bridge 2100 that is above the upper design limit of the circuit, can be referred to as Vsense-over. The acceptable over voltage should be lower than Vsense-over.

The ESDs 2400, 2500, 2600 can for example be Metal Oxide-Semiconductor Field-Effect Transistors, MOSFETs, bipolar transistors, silicon-controlled rectifier, etc. Furthermore, the ESDs can for example be n-type MOSFETs or p-type MOSFETs. The controller 2800 can be an external or an internal component of the power supply 2000. In other words, the controller and the rectifier can either be implemented as separate physical entities or as a single physical entity in for example, as a single unit in a common box or with a common cover. The resistor 2300 can for example be either a carbon film resistor or a metal oxide resistor or a metal strip resistor or carbon composition resistor or a thick film resistor or a wire wound resistor. The resistor 2300 can be a different type of resistor from the ones listed above.

When the power supply of FIG. 2 is in use, an AC voltage is applied to the rectifier bridge for converting the AC voltage to DC voltage. The controller monitors the current passing through resistor 2300 and Vsense. The voltage across the capacitor 2700 can be referred to as Vc.

Further, to improve the understanding of the reader, the placement of the various components in the disclosed power supply 2000 will be described in relation to a first terminal 2101 of the rectifier bridge 2000, a second terminal 2102 of the rectifier bridge 2000, a first terminal 2701 of the capacitor 2700 and a second terminal 2702 of the capacitor 2700. The first terminals 2701, 2101 and second terminals 2702, 2102 of the capacitor 2700 and the rectifier bridge 2100, respectively are referred to as the first DC terminal and second DC terminal of each component, respectively. The rectifier bridge 2100 is placed at the input voltage connections of the AC input voltage 2900 of the power supply 2000. The capacitor 2700 is placed at the power supply 2000 output. The first DC terminal 2701 of the capacitor 2700 is connected to the first DC terminal 2101 of the rectifier bridge 2100, and the second DC terminal 2702 of the capacitor 2700 is connected to the second DC terminal 2102 of the rectifier bridge 2100. There could be other components of the power supply 2000 placed in between the rectifier bridge 2100 and the capacitor 2700. A drain of ESD 2400 is connected to the first DC terminals of the capacitor and the rectifier bridge 2701, 2101, and a source of ESD 2400 is connected to the second DC terminals of the capacitor and the rectifier bridge 2702, 2102. Second ESD 2500 and third ESD 2600 are positioned between the first DC terminals of the capacitor and the rectifier bridge 2701, 2101 such a drain of ESD 2500 and a drain of ESD 2600 is connected, a source of ESD 2600 is connected to the drain of ESD 2400, and a source of the ESD 2500 is connected to the first DC terminal of the capacitor 2701. The inductor 2200 can be positioned between the first DC terminal 2101 of the rectifier bridge 2100 and the drain of the first ESD 2400. The resistor 2300 can be positioned between the second DC terminal 2102 of the rectifier bridge 2100 and the source of the first ESD 2400. The controller 2800 of the example in FIG. 2 comprises a first, second and third input line 2801, 2802, 2808 and a first, second and third output line 2805-2807. The controller's three output lines 2805, 2806, 2807 provide input to, and are connected to the gates of, the three ESDs 2400, 2500, 2600, respectively. The first, second and third input lines 2801, 2802, 2808 of the controller 2800 are configured to receive a first, second and third signal, respectively. Times at which the ESDs 2400, 2500 and 2600 are turned on are referred to as the switching times for each of the ESDs. The switching times for the first, second and third ESDs 2400, 2500 and 2600 can be different. Also, the inductor 2200, the resistor 2300, the second ESD 2400 and third ESD 2500 can be part of a boost converter. The power supply described herein can also be used for a communications network node 9100 and a computing system 9200.

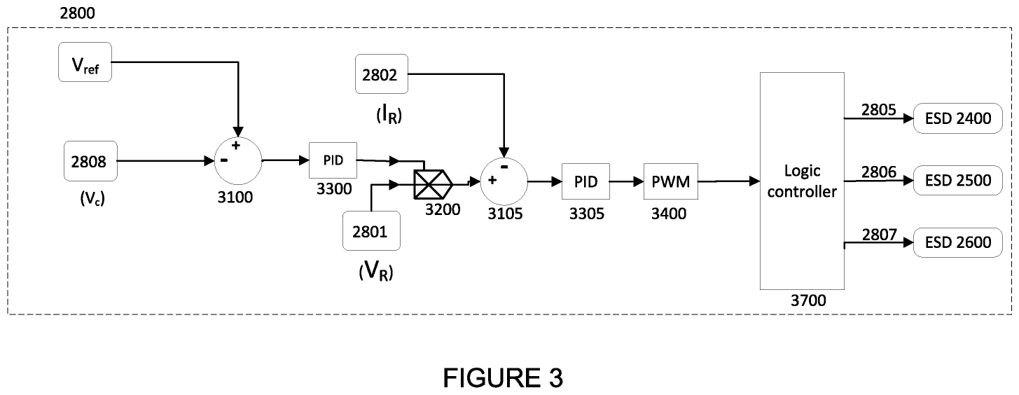

FIG. 3 is a schematic representation of an embodiment of the controller 2800. The first and second inputs 2801, 2802 at the controller 2800 are connected across the two ends of the resistor 2300, and the third input at the controller 2808 is connected to the first DC terminal 2701 of the capacitor 2700. The first input line 2801 receives a voltage indicative of the voltage across resistor 2300, VR. The second input line 2802 receives a current indicative of the current through resistor 2300, IR. The first, second and third output lines 2805-2807 of the controller 2800 are used to trigger the first ESD 2400, the second ESD 2500 and the third ESD 2600, respectively. The controller 2800 illustrated in FIG. 3 comprises two signal adders 3100, 3105, a signal multiplier 3200, two proportional-integral-derivative, PID, controllers 3300, 3305, a pulse wave modulator, PWM, 3400 and a logic controller 3700. The logic controller 3700 is adapted/configured/operable to generate output signals such that the input of ESD 2600 is the inverse of the input of ESD 2400. Furthermore, the logic controller 3700 is configured to generate an output signal such that the input to ESD 2500 is the same as either the first or third output line or any other input.

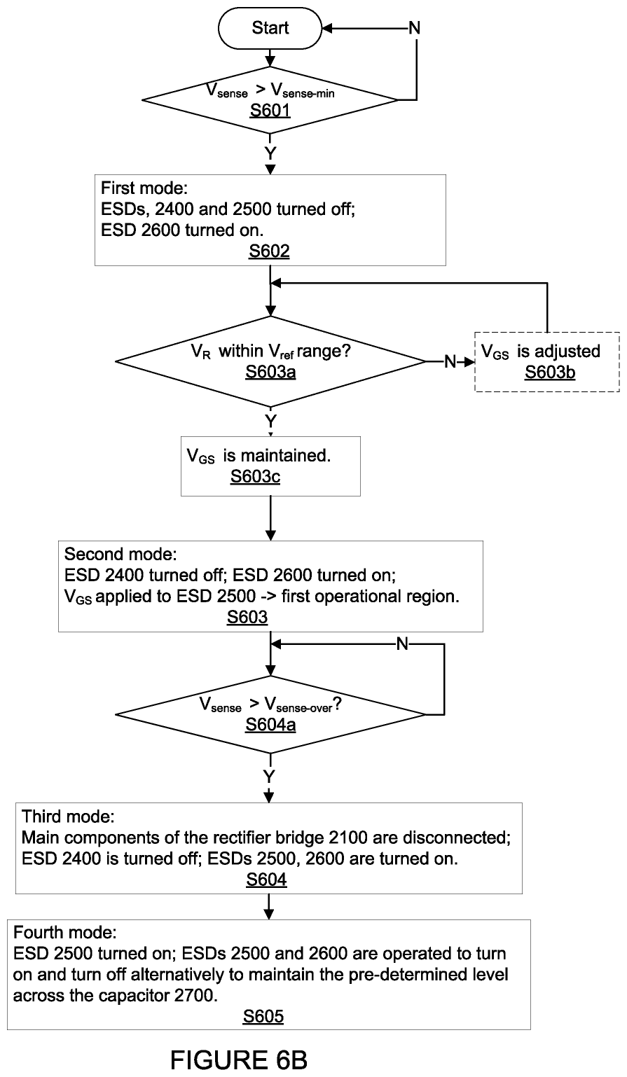

The controller 2800 of FIG. 3 is adapted/configured/operable to add a predetermined reference voltage, Vref, with the negative of the voltage across capacitor 2700, Vc, at a first signal adder 3100. The output from the first signal adder 3100 is connected to a first PID 3300. The output from the first PID 3300 is connected to a signal multiplier 3200. Another input of the signal multiplier 3200 of FIG. 3 is connected to the resistor 2300 and is configured to receive a voltage indicative of the voltage across resistor 2300, VR. The output of the signal multiplier 3200 is connected to a second signal adder 3105. The second signal adder 3105 is configured to combine the output of the signal multiplier with an incoming current, IR, indicative of the negative of the current through the resistor 2300. The output of the second signal adder 3105 is connected to a second PID 3305. The output of the second PID 3305 is connected to the PWM 3400. The logic controller 3700 is configured to compare the output of this PWM 3400 against the predetermined voltage threshold of the capacitor 2300. The predetermined voltage threshold of the capacitor 2300 is different from the predetermined level of the capacitor. The predetermined threshold of the capacitor is determined based on the design parameters of the power supply. The logic controller 3700 is further configured to provide input to the three ESDs 2400, 2500 and 2700 based on three different conditions. The logic controller 3700 can either turn on or turn off an ESD by applying a signal at the gate of the ESD. Hence, output from the logic controller can be referred to as the gate driver or the trigger. Furthermore, the logic controller is configured to provide input to the ESD 2600 and ESD 2400, wherein the input to one of the ESDs is conjugate of the other. Moreover, the logic controller presented in this solution can be implemented in different ways. In an example embodiment, the logic controller 3700 comprises at least one comparator. The comparator is used to compare the incoming signals with a reference such as the reference voltage, Vref. In another example embodiment, the logic controller comprises a flip flop configured as per user requirements. The flip flop can, in some examples, be configured to implement a logic such as AND, OR, XOR, NOR, NAND or other such digital logic. In addition to a comparator and/or a flip flop, the logic controller 3700 can, in some examples, additionally comprise an amplifier, a converter and/or a buffer. The amplifier, converter and buffer being used to produce an output by altering the physical properties of any incoming signal. In another example, the controller 2800 is implemented via the processing circuitry 710 in FIG. 7, respectively, and/or via software code. Also, the controller 2800 is configured to control either one or several electronic apparatuses and either one of several computing system.

Depending upon the relative voltages of its terminals, an ESD can operate in either of three operating regions-the cut-off, linear or saturation region. The three triggers or output lines 2805-2807 of the controller 2800 can alternatively be called gate drivers. A gate driver can apply both current and voltage to a gate of an ESD for turning the ESD on or off. This way the ESD can be controlled to switch between the operating regions. The current or voltage from the controller could be either positive or negative depending on the application. In some modes, the applied current or voltage at the input of the power supply is positive, that is, greater than zero. The disclosed power supply follows a control method based on the controller configured to operate in one of four modes of operation. In an embodiment, the four modes of operation are sequential in nature, that is, the controller is configured to trigger a first mode upon receiving an AC voltage greater than the minimum voltage Vsense-min. The controller is configured to trigger a second mode after the first mode. The controller is configured to trigger a third mode after the second mode. The controller is configured to trigger a fourth mode after the third mode. The second, third and fourth mode operate only upon triggering of the necessary conditions. In idle state, when there is no power supply to the circuit, the three ESDs, 2400, 2500, 2600 are turned off and voltage across capacitor, Vc, is 0 V. In case any AC input voltage 2900 is applied to the inrush limiter circuit 2000, the controller 2800 gets triggered. The turning on or turning off of the ESDs 2400, 2500, 2600 can be referred to as operating state of the ESDs. As mentioned earlier, the controller is configured to control the power supply to operate according to one of the four modes of operation.

In the first mode of operation, when the applied input AC voltage 2900 reaches the minimum voltage Vsense-min, the controller 2800 is configured to control the three ESDs 2400, 2500, 2600 via the controller's first, second and third output lines 2805-2807, such that first and second ESDs 2400, 2500 are turned off, while the third ESD 2600 is turned on. The first mode of operation is completed once the three ESDs 2400, 2500, 2600 attain the aforementioned operating conditions.

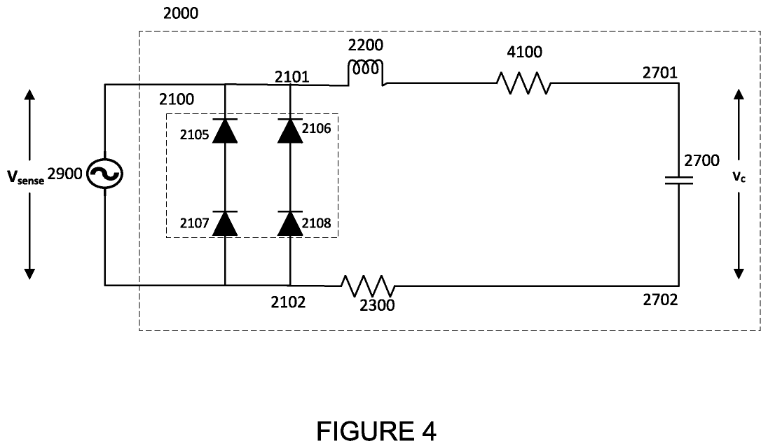

FIG. 4 shows an equivalent circuit for the power supply in the second mode of operation. The second mode of operation is triggered upon completion of the first mode of operation and if the voltage across the capacitor is less than a predetermined level. In the second mode of operation, the controller 2800 is configured to apply a voltage on the Gate-Source junction, VGs, of the second ESD 2500, to drive ESD 2500 to its linear region. In the linear region, ESD 2500 acts as a resistor 4100 and hence, the circuit obtained is equivalent of an RLC loop to charge up the capacitor 2700, to the pre-determined level. The pre-determined level can for example be the voltage setting of the capacitor 2700 capacitor and can be based on design parameters of the power supply. The pre-determined level can be set internally in the PFC circuit, more specifically, in the controller 2800. Degenerative feedback, also known as negative feedback, is employed by feeding back the voltage at the capacitor to the equivalent RLC loop so as to maintain the charging current at capacitor 2700 until a pre-determined voltage level has been reached.

The voltage across resistor 2300, VR, can be used to determine the current in the equivalent RLC loop as shown in FIG. 2. After determination of the voltage across resistor 2300, VR, the voltage across resistor 2300 VR, is increased and compared with a reference voltage, Vref. The controller 2800 is configured to use the difference between the voltage across resistor 2300, VR, and Vref to adjust the voltage at the Gate-Source junction of ESD 2500. The controller is configured to reduce VGs if the measured voltage across resistor 2300 is higher than Vref else if the measured voltage across resistor 2300 is lower than Vref, the controller is configured to increase Vos else if the measured voltage across resistor 2300 is equal to the Vref, the Vos is maintained. In this way, the pre-determined level of inrush current is maintained during the start-up of the electronic apparatus 9000 to which the power supply 2000 is connected, that is, when an input AC voltage 2900 is applied at the input terminals of the PFC 2005. Start-up for the power supply reaches its end when the voltage across capacitor 2700, Vc, reaches the pre-determined level and current through resistor 2300 reduces. The second mode of operation can alternatively be referred to as the inrush mode of operation.

In the third mode of operation, the power supply 2000 is configured such that main components of the rectifier bridge 2100 are disconnected if the input AC voltage 2900 is greater than the over voltage Vsense-over. In this mode, the controller is configured to turn off the first ESD 2400, and subsequently turn on the second and third ESDs, 2500 and 2600 when a voltage across the capacitor is greater than the predetermined level. The controller 2800 is configured to control the second ESD 2500 to operate in its linear region, hence, the power supply 2000 continues to charge capacitor 2700. When the voltage across the capacitor 2700, Vc, is close to the voltage rating of the capacitor 2700, ESDs 2500, 2600 are turned off. At this time, if current still exists at inductor 2200, the controller is configured to impose an additional reversed voltage on the first and second ESDs 2400, 2500. After the input voltage, Vsense, returns to a level below the maximum acceptable voltage V sense-max, the controller is configured to turn on the second ESD 2500. This particular operation in which the additional reversed voltage is imposed is to protect a connected electronic apparatus from voltage sag or voltage swelling.

In the fourth mode of operation, the controller 2800 turns on the second ESD 2400, and the first and third ESDs, 2500 and 2600 are operated by the controller 2800 to turn on and turn off alternatively to maintain the pre-determined level across the capacitor 2700. This mode of operation can be referred to as the normal mode of operation and is activated when a current at the input reduces to an acceptable operational current and the voltage across the capacitor reaches a predetermined voltage threshold.

In an embodiment, the controller 2800 is configured to operate the power supply in a fifth mode of operation wherein the first, second and third ESDs 2400, 2500, 2600 are turned off. The fifth mode can be entered directly from any of the other modes of operation. Thus, it is not based on sequential operation.

In an embodiment, the power supply 2000 comprises a voltage clamping device 2705, to prevent damage to ESD 2400 and ESD 2500 during this transient stage. The voltage clamping device 2705 is in this embodiment connected in parallel with ESD 2400. Moreover, the voltage clamping device 2805 could be a varistor; voltage dependent resistor, VDR; or any other component with similar function.

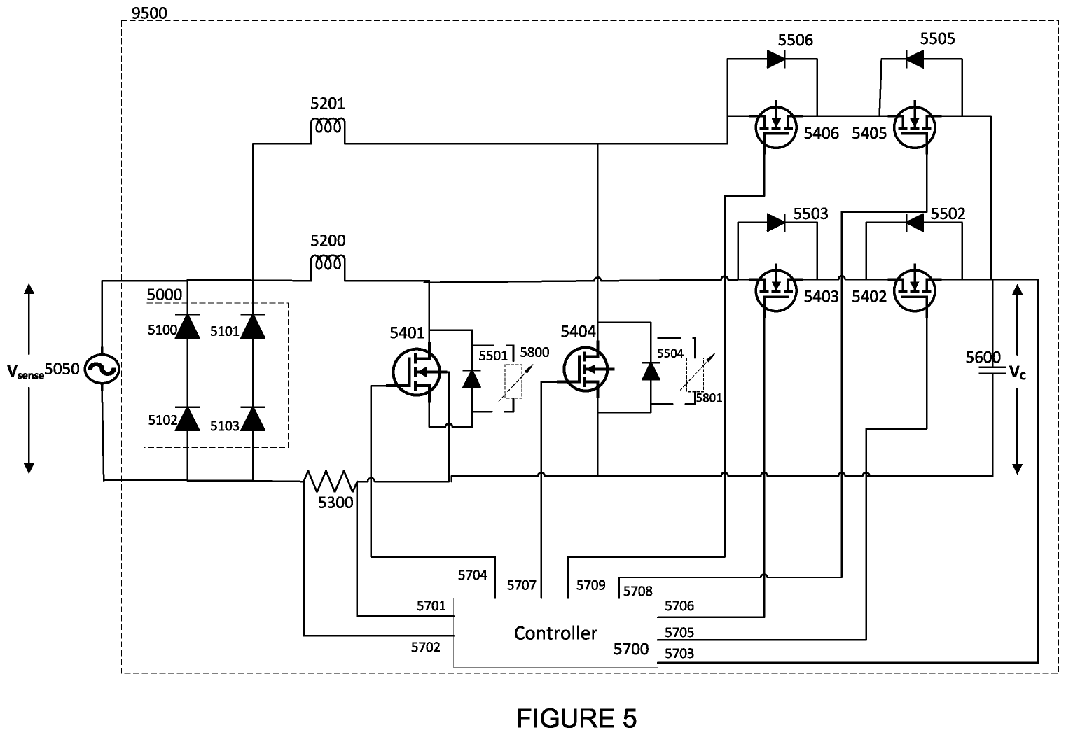

FIG. 5 shows an embodiment of the power supply with an interleaved PFC 9500. The embodiment comprises an input AC supply 5050, a rectifier bridge 5000 comprising four diodes 5100-5103; two inductors 5200, 5201; a resistor 5300; six ESDs 5401-5406 with corresponding body diodes 5501-5506; a capacitor 5600; a controller 5700; and optionally, two voltage clamping devices 5800, 5801. The ESDs 5401, 5402 and 5403 operate in a similar manner as the ESDs 2400, 2500 and 2600 respectively. The ESDs 5403, 5404, 5405 perform similar operations to those performed by

ESDs 5401, 5402 and 5403, respectively. The four modes of operation mentioned in the previous embodiment can also be applied to such a circuit. In an embodiment, the controller 5700 is configured to control all the ESDs 5401-5406 in a synchronized manner such that approximately, ESDs 5401 and 5404, 5402 and 5405, and 5403 and 5406 work in one after another in the time domain. The controller 5700 of the example in FIG. 5 comprises a first, second and third input line 5701-5703 and a first, second, third, fourth, fifth and sixth output line 5704-5709. The controller's six output lines 5704-5709 provide input to, and are connected to the gates of, the six ESDs 5401, 5402, 5403, 5404, 5405, 5406, respectively. The first, second and third input lines 5701, 5702, 5703 of the controller 5700 are configured to receive a first, second, third, fourth, fifth and sixth signal, respectively. Times at which the ESDs 5401-5406 are turned on are referred to as the switching times for each of the ESDs. The switching times for the first, second, third, fourth, fifth and sixth ESDs 5401-5406 can be different. In another embodiment, diodes 5100-5103 can be replaced with ESDs. In yet another embodiment, another interleaved PFC layer can be added on top of the embodiment as described above.

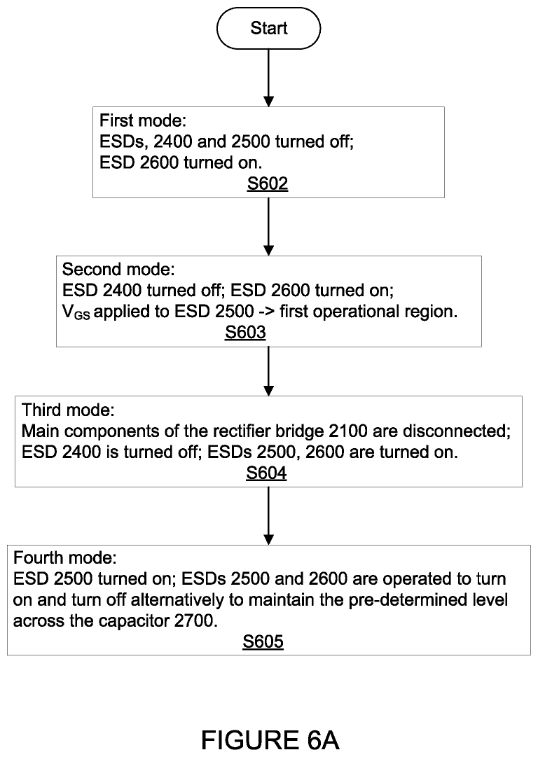

FIG. 6A is a flowchart depicting embodiments of a method in a power supply. S600 controller 2800 controls the switching of the first, second and third ESDs 2400, 2500, 2600 by applying a signal to each ESD. The controller 2800 triggers the different ESDs 2400, 2500, 2600 in the power supply 2000 to turn the ESDs 2400, 2500, 2600 ‘on’ or ‘off’ as per one of the four modes of operation. Each subsequent mode of operation after the first mode of operation is triggered once the previous mode of operation has finished. S602 is entered, wherein the controller 2800 controls the three ESDs 2400, 2500, 2600 in a first mode of operation, such that the first and second ESDs, 2400 and 2500 are turned off while the third ESD 2600 is turned on. S603 is entered, wherein the controller in a second mode of operation applies Vos on the Gate-Source junction of the second ESD 2500 to drive ESD 2500 to make the ESD 2500 operate in a first operational region. Also, the capacitor 2700 is charged to a pre-determined level. S604 is entered wherein the controller controls the power supply to operate in a third mode of operation, wherein the controller disconnects the main components of the rectifier bridge 2100. Also, the controller 2800 controls the ESD 2400 to turn off and subsequently controls the second and third ESDs 2500 and 2600 to turn on, while charging the capacitor 2700. S605 is entered, wherein the controllers control the three ESDs to make the power supply operate in a fourth mode of operation. The controller 2800 controls the second ESD 2500 to turn on, and the first and third ESDs 2500 and 2600 to turn on and turn off alternatively while maintaining the pre-determined level across the capacitor 2700.

FIG. 6B is a flowchart depicting an embodiment of the method in a power supply. S601 is entered wherein the controller 2800 controls the three ESDs 2400, 2500, 2600 to operate the power supply to check the condition: Vsense greater than Vsense-min is checked. If Vsense less than Vsense-min, the process is repeated. S602 is entered, wherein the controller 2800 controls the power supply to operate in the first mode of operation, and checks if Vsense >Vsense-min is true, the controller 2800 controls the three ESDs 2400, 2500, 2600, such that the first and second ESDs, 2400 and 2500 are turned off while the third ESD 2600 is turned on. S603a is entered wherein the condition: voltage across resistor 2300, VR, within Vref range is checked. S603b is entered, wherein the controller controls the three ESDs to operate the power supply in a second mode of operation. If VR is not within an acceptable range of Vref, the controller adjusts the Voltage at the Gate-Source junction of ESD 2500, VGs. S603c is entered, wherein if VR is within an acceptable range of Vref, the controller maintains the VGs. S603 is entered, wherein the controller applies VGs on the Gate-Source junction of the second ESD 2500 to drive ESD 2500 to make the ESD 2500 operate in a first operational region. Also, the capacitor 2700 is charged to a pre-determined level. S604a is entered wherein the condition: Vsense >V sense-over is checked. S604 is entered, wherein the controller controls the power supply to operate in a third mode of operation, and the controller disconnects the main components of the rectifier bridge 2100 if Vsense >Vsense-over. Also, the controller 2800 controls the ESD 2400 to turn off and subsequently controls the second and third ESDs 2500 and 2600 to turn on, while charging the capacitor 2700. S605 is entered, wherein the controllers control the three ESDs to make the power supply operate in a fourth mode of operation. The controller 2800 controls the second ESD 2500 to turn on, and the first and third ESDs 2500 and 2600 to turn on and turn off alternatively while maintaining the pre-determined level across the capacitor 2700.

The power supply 2000 when used with an electronic apparatus 9000 enables proper functioning of an electronic apparatus 9000.

In an embodiment, in S603b, when VR is not within an acceptable range of Vref, the Vos is either increased or decreased. In other words, in S603b, when VR is greater than Vref, the Vos is decreased or when VR is lesser than Vref, the Vos is increased. In an embodiment, the first operational mode for ESD 2500 is a linear mode in the third mode of operation. In another embodiment, the first operational mode for ESD 2500 is a saturation mode in the third mode of operation.

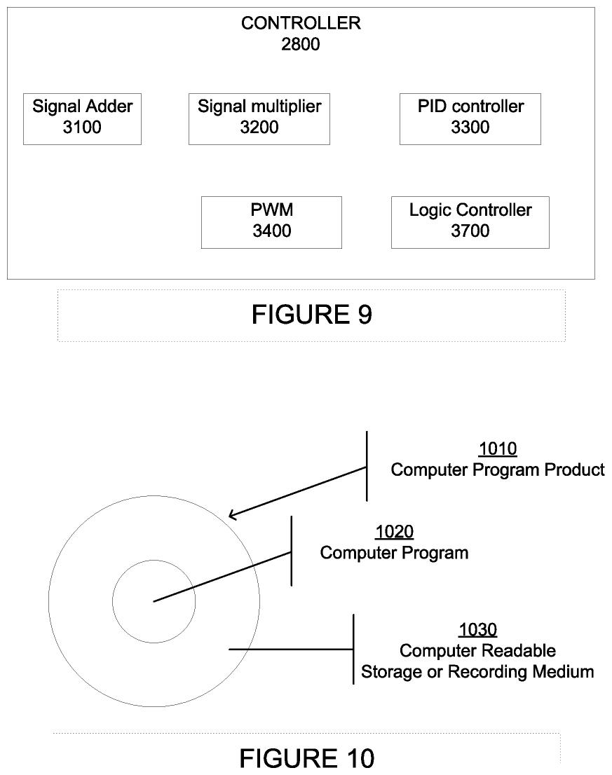

FIG. 7 illustrates an example of a controller 2800 as implemented in accordance with one or more embodiments. A processing circuitry 710 is adapted/configured/operable to cause the controller to perform a set of operations, or steps, S602, S603, S604, S605 as disclosed above, e.g., by executing instructions stored in memory 730. The processing circuitry 710 may comprise one or more of a microprocessor, a controller, a microcontroller, a central a processing unit, a digital signal processor, an application-specific integrated circuit, a field programmable gate array, or any other suitable computing device, resource, or combination of hardware, software and/or encoded logic operable to provide, either alone or in conjunction with other components of controller 2800, such as the memory 730, in order to provide relevant functionality. The processing circuitry 710 in this regard may implement certain functional means, units, or modules. Memory 730 may include one or more non-volatile storage medium and/or one or more volatile storage medium or a cloud-based storage medium. In embodiments where processing circuitry 710 includes a programmable processor 740, a computer program product 1010 may be provided in controller 2800. Such computer program product is described in relation to FIG. 10.

The memory 730 may store any suitable instructions, data, or information, including software, an application including one or more of logic, rules, code, tables, and/or other instructions/computer program code capable of being executed by the processing circuitry 710 and utilized by the controller 2800. The memory 730 may further be used to store any calculations made by the processing circuitry 710 and/or any data received via the communication circuitry 720, such as input from any of the three input lines 2801, 2802, 2808, etc. In some embodiments, the processing circuitry 710 and memory 730 are integrated. The controller 2800 of FIG. 7 includes the processing circuitry 710 and the Input/Output, I/O, Interface circuitry 720. The I/O Interface circuitry 720 is configured to transmit and/or receive information to and/or from one or more other electronic apparatus, e.g., via input cable lines. Transmission and/or reception of at least one signal may occur via one or more input or output lines, that are either internal or external to the controller 2800.

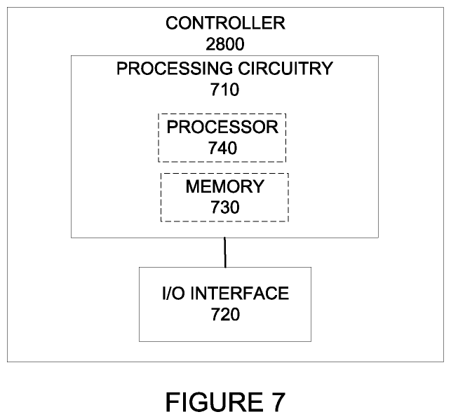

FIG. 8a illustrates a schematic block diagram of a power supply 2800 placed inside an electronic apparatus 9000 according to one or more embodiments. FIG. 8b illustrates a schematic block diagram of a power supply 2800 placed outside an electronic apparatus 9000 according to one or more embodiments.

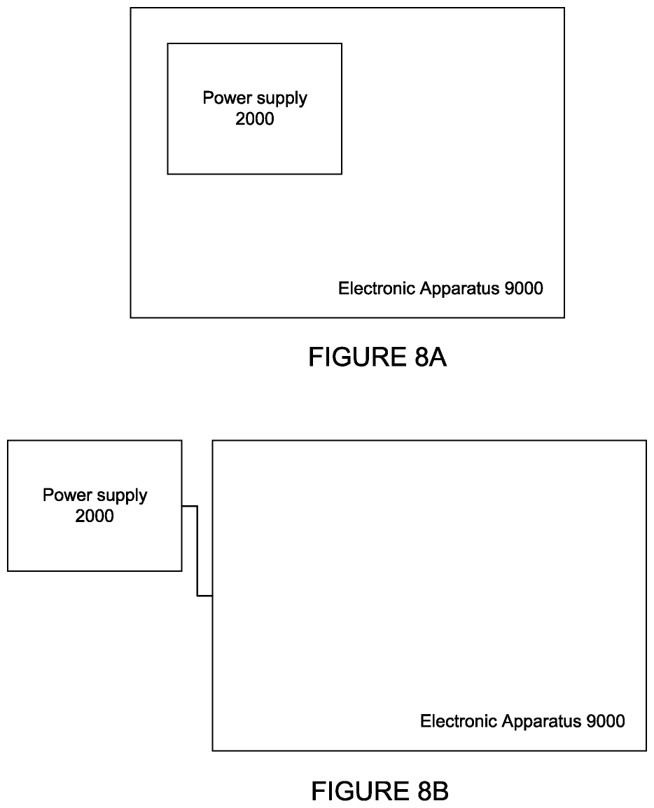

FIG. 9 illustrates a schematic block diagram of a controller 2800 according to still other embodiments. As shown, the controller 2800 implements various functional means, units, or modules, e.g., via the processing circuitry 710 and/or via software code. These functional means, units, or modules, e.g., for implementing the method(s) herein, can for example include, a signal adder 3100, a signal multiplier 3200, a proportional-integral-derivative, PID, controller 3300, a pulse wave modulator, PWM, 3400 and a logic controller 3700.

FIG. 10 shows one example of a computer program product. Computer readable medium 1030 of the controller 2800, may be a non-transitory computer readable medium, such as, magnetic media (e.g., a hard disk), optical media, memory devices (e.g., random access memory, flash memory), and the like. Computer program product 1010 includes a computer readable storage medium 1030 storing a computer program 1020 comprising computer readable instructions. In some embodiments, the computer readable instructions of computer program 1020 are configured such that when executed by processing circuitry 710, the computer readable instructions cause the controller 2800 to perform steps described herein (e.g., S602, S603, S604, S605). In other embodiments, the controller 2800 may be configured/operable to perform steps described herein without the need for code. That is, for example, processing circuitry 710 may consist merely of one or more ASICs. Hence, the features of the embodiments described herein may be implemented in hardware and/or software.

The computer program product 1010 of FIG. 10 comprises a computer program 1020 and a computer readable storage medium 1030 on which a computer program is stored, where the computer program, when run on the processing circuitry causes the power supply to execute any or all of the various embodiments herein.

The computer program code mentioned above may also be provided, for instance in the form of a data carrier carrying computer program code for performing the embodiments herein when being loaded into the hardware. One such carrier may be in the form of a CD ROM disc. It is however feasible with other data carriers such as a memory stick. The computer program code may furthermore be provided as pure program code on a server and downloaded to the hardware device at production, and/or during software updates.

The person skilled in the art realizes that the invention by no means is limited to the embodiments described above. On the contrary, many modifications and variations are possible within the scope of the appended claims. Examples of base station include, but are not limited to, Node Bs, evolved Node Bs (eNBs), NR nodeBs (gNBs), radio access points (APs), relay nodes, remote radio head (RRH), a node in a distributed antenna system (DAS), etc. The disclosed power supply does not have any operating limitations such as a specific current or voltage range to consider. The power supply as described in the various embodiments herein reduces the effect of the variable inrush current generated towards the power grid by an electronic apparatus. Another advantage of the various embodiments is that the efficiency of the power grid is increased. The power grid may for example be an electricity grid, power station, power house, micro grid, energy supply station, etc.

Those skilled in the art will also appreciate that the blocks in the circuit diagram of the power supply may refer to a combination of analog and digital circuits, and/or one or more controllers, configured with software and/or firmware, e.g. stored in one or more local storage units, that when executed by the one or more controllers perform as described above. One or more of these controllers, as well as any other combination of analog and digital circuits, may be included in a single application-specific integrated circuitry (ASIC), or several controllers and various digital hardware may be distributed among several separate components, whether individually packaged or assembled into a system-on-a-chip (SoC). The one or more controllers may be any one of, or a combination of a central processing unit (CPU), graphical processing unit (GPU), programmable logic array (PAL) or any other similar type of circuit or logical arrangement.

1-52. (canceled)

53. A power supply, the power supply adapted to convert an oscillating Alternating Current (AC) to a single-directional Direct Current (DC), the power supply comprising:
(1) a rectifier bridge at an input, the rectifier bridge having a first DC terminal and a second DC terminal;
(2) a capacitor at an output, the capacitor having a first DC terminal connected to the first terminal of the rectifier bridge and a second DC terminal connected to the second terminal of the rectifier bridge;
(3) at least a first, a second and a third Electronic Switching Device (ESD), wherein:
a drain of the first ESD is connected to the first DC terminals,
a source of the first ESD is connected to the second DC terminals, and
the second and third ESDs are connected between the first DC terminals such that a drain of the second ESD is connected to a drain of the third ESD, a source of the third ESD is connected to the drain of the first ESD, and a source of the second ESD is connected to the first DC terminal of the capacitor;
(4) an inductor connected between the first DC terminal of the rectifier bridge and the drain of the first ESD;
(5) a resistor connected between the second DC terminal of the rectifier bridge and the source of the first ESD;
(6) a controller connected to the first, second and third ESDs, wherein
the controller is adapted to control switching of the first, second and third ESDs to operate the power supply in at least four modes of operation comprising:
i) a first mode of operation in which the first and the second ESDs are turned off, and the third ESD is turned on,
ii) a second mode of operation in which the first ESD is turned off, the third ESD is turned on and the second ESD operates in a linear region,
iii) a third mode of operation in which the first ESD is turned off, the second and third ESDs are turned on, and
iv) a fourth mode of operation in which the second ESD is turned on, and the first ESD and third ESD are operated to turn on and turn off alternatively to maintain a predetermined level of a voltage across the capacitor, and
the power supply is adapted to enter the four modes of operation sequentially.

54. The power supply of claim 53, wherein the controller is adapted to control the switching of the first, second and third ESDs to operate the power supply in a fifth mode of operation, wherein the first, second and third ESDs are turned off and wherein the fifth mode of operation is entered directly from any of the first, the second, the third or the fourth modes of operation.

55. The power supply of claim 53, wherein the power supply is adapted to receive a signal at the input to activate the first mode.

56. The power supply of claim 53, wherein the power supply is adapted to activate the second mode if the voltage across the capacitor is less than the predetermined level.

57. The power supply of claim 53, wherein the power supply is adapted to activate the third mode when a voltage across the capacitor is greater than the predetermined level.

58. The power supply of claim 53, wherein the predetermined level is a predetermined voltage.

59. The power supply of claim 53, wherein power supply is adapted to activate the fourth mode when the AC at the input reduces to an acceptable operational current and the voltage across the capacitor reaches a predetermined voltage threshold, wherein the acceptable operational current is based on the value of the resistance of resistor, inductance of inductor, capacitance of capacitor and frequency of the ESDs.

60. The power supply of claim 53, wherein a voltage clamping device is connected in parallel to the first ESD.

61. The power supply of claim 53, wherein the first, second and third ESDs are MOSFETs.

62. The power supply of claim 53, wherein the predetermined level of the signal across the capacitor is based on design parameters of the power supply.

63. The power supply of claim 53, wherein the fourth mode of operation is a normal mode of operation.

64. The power supply of claim 53, wherein switching times for the first, second and third ESDs are different.

65. The power supply of claim 53, wherein the inductor, the resistor, the second ESD and third ESD are part of a boost converter.

66. The power supply of claim 53, wherein the power supply comprises an interleaved PFC circuit comprising an ESD with a corresponding body diode, an ESD with a corresponding body diode and an ESD with a corresponding body diode, wherein the ESD, the ESD and the ESD are connected in parallel to the ESD, the ESD and the ESD, respectively.

67. The power supply of claim 53, wherein the first DC terminal of the rectifier bridge is a positive terminal and the second DC terminal of the rectifier bridge is a negative terminal.

68. The power supply of claim 53, wherein the controller comprises a first, a second and a third input line and a first, a second and a third output line, wherein the first, second and third input lines of the controller are adapted to receive a first, second and third signal, respectively.

69. The power supply of claim 53, wherein the controller comprises a logic controller, a signal adder, a signal multiplier, a proportional-integral-derivative, PID, controller and a pulse wave modulator, PWM.

70. An electronic apparatus comprising the power supply of claim 53.

71. A method performed by a power supply, the power supply adapted to convert an oscillating Alternating Current (AC) to a single-directional Direct Current (DC), the power supply comprising:
(1) a rectifier bridge at an input, the rectifier bridge having a first DC terminal and a second DC terminal;
(2) a capacitor at an output, the capacitor having a first DC terminal connected to the first terminal of the rectifier bridge and a second DC terminal connected to the second terminal of the rectifier bridge;
(3) at least a first, a second and a third Electronic Switching Device (ESD), wherein:
a drain of the first ESD is connected to the first DC terminals,
a source of the first ESD is connected to the second DC terminals, and
the second and third ESDs are connected between the first DC terminals such that a drain of the second ESD is connected to a drain of the third ESD, a source of the third ESD is connected to the drain of the first ESD, and a source of the second ESD is connected to the first DC terminal of the capacitor;
(4) an inductor connected between the first DC terminal of the rectifier bridge and the drain of the first ESD;
(5) a resistor connected between the second DC terminal of the rectifier bridge and the source of the first ESD;
(6) a controller connected to the first, second and third ESDs, wherein the method comprises:
the controller controlling switching of the first, second and third ESD to operate the power supply in at least one of four modes of operation comprising:
i) a first mode of operation in which the first and the second ESDs are turned off, and the third ESD is turned on,
ii) a second mode of operation in which the first ESD is turned off, the third ESD is turned on and the second ESD operates in a linear region,
iii) a third mode of operation in which the first ESD is turned off, the second and third ESDs are turned on, and
iv) a fourth mode of operation in which the second ESD is turned on, and the first ESD and third ESD are operated to turn on and turn off alternatively to maintain a predetermined level of a voltage across the capacitor, wherein
the four modes of operation are entered sequentially.

72. A computer program product stored on a non-transitory computer readable storage or recording medium and comprising instructions that, when executed by a processor of an apparatus, cause the apparatus to perform the method according to claim 71.
